(19) United States
(12) Patent Application Publication
(10) Pub. No.: US 2010/0224143 A1
(43) Pub. Date: Sep. 9, 2010

(54) OIL SPRAY LUBRICATION AND COOLING DEVICE FOR A VARIABLE COMPRESSION RATIO ENGINE

(76) Inventor: Vianney Rabhi, Lyon (FR)

Correspondence Address: YOUNG & THOMPSON, 209 Madison Street, Suite 500, Alexandria, VA, 22314, US

(21) Appl. No.: 12/160,429

(22) PCT Filed: Jan. 26, 2007
(86) PCT No.: PCT/FR07/00146

§ 371 Date: Jan. 8, 2009

Related U.S. Application Data
(60) Provisional application No. 60/762,869, filed on Jan. 30, 2006.

(30) Foreign Application Priority Data
Jan. 26, 2006 (FR) 06/00713

(51) Int. Cl. F01P 1/04; F02B 75/04; F01M 1/02

(52) U.S. Cl. 123/41.39; 123/48 B; 123/196 R

(57) ABSTRACT

The invention relates to an oil spray lubrication and cooling device for a variable compression ratio engine, including at least one injector (701, 712, 713) which is placed in the engine block (100) of the variable compression ratio engine such as to spray oil onto at least one of the moving components of the engine. The aforementioned moving components include at least one piston (2), the lower part of which is solidly connected to a transmission element (3) that co-operates with a rolling guide device (4) and a toothed wheel (5) which co-operates with (i) a connecting rod (6) which is connected to a crankshaft (9) and (ii) a control rack (7) opposite the transmission element (3). The vertical position of the control rack in relation to the engine block (100) is controlled by a control device (12).

The subject of the present invention is a device which cools the piston and lubricates the gear system of a variable compression ratio engine.

According to international patents WO 98/51911, WO 00/31377 and WO 03/008783 belonging to the applicant, various mechanical devices for a variable compression ratio engine are known.

It is noted that international patent WO 98/51911 in the name of the applicant describes a device being used to improve the overall performance of internal-combustion piston engines used with variable loads and speeds by adjusting their effective cubic capacity and/or their compression ratio while they are running.

It is observed that, according to international patents WO 00/31377 and WO 03/008783 in the name of the applicant, the mechanical transmission device for a variable compression ratio engine comprises at least one cylinder in which a piston moves, the lower portion of which is solidly connected to a transmitting member cooperating on the one hand by means of a small rack with a rolling guide device, and on the other hand by means of another large rack with a toothed wheel solidly connected to a connecting rod, this making it possible to transmit the movement between said piston and said connecting rod.

Said mechanical transmission device for a variable compression ratio engine also comprises at least one control rack cooperating with the toothed wheel, means of attaching the piston to the transmitting member which provide a pre-tightening, connecting means which stiffen the teeth of the racks, and means of strengthening and lightening the structure of the toothed wheel.

It is noted that the piston of the variable compression ratio engine has a special shape which differs from that of the pistons of conventional engines.

It is known to the person skilled in the art that variable compression ratio engines, regardless of their mechanical principle, are intended to be boosted by a turbocharger or any other means of supercharging in many applications.

The variable compression ratio engine described by the abovementioned patents is also very advantageous when it is connected to a supercharging device: this enables it to deliver a high specific torque and power and replace a conventional normally-aspirated engine of greater cubic capacity. This strategy makes it possible to reduce the fuel consumption of vehicles without reducing their performance.

One of the problems posed by supercharged engines is the control of the temperature of the pistons which receive a quantity of heat that increases as the supercharging pressure rises. To solve this problem, the pistons of conventional supercharged engines are usually cooled by oil injectors which spray oil under the crown of said pistons.

It is noted that none of the patents belonging to the applicant discloses a device intended to cool the piston(s) of the variable compression ratio engine, yet, in the absence of such a device, said piston(s) of said engine run(s) the risk of reaching an excessively high operating temperature which can lead to its/their destruction.

It is also observed that the variable compression ratio engine includes a gear system for transmitting and guiding the power which does not exist in conventional engines. Said gear system is composed of the transmitting member solidly connected to the piston of the engine which includes a large rack and which cooperates with the toothed wheel, said wheel also cooperating with the control rack.

It is also noted that said gear system is also composed of small racks which cooperate with small toothed wheels arranged at each of the ends of a synchronized roller, said small racks, said small toothed wheels and said synchronized roller being part of the rolling guide device of the variable compression ratio engine.

It is observed that the gear system is mainly lubricated by the oil spray present in the engine block of the variable compression ratio engine when it is operating, said spray being produced in particular by the oil splashed in said engine block by the hydrodynamic bearings of said engine.

However, according to the geometric configuration of the engine block of the variable compression ratio engine, said oil spray may prove to be insufficient to provide the gear system with sufficient lubrication, in which case the surfaces of the teeth of said system can wear prematurely or be destroyed.

It is to control the temperature of the piston(s) of the variable compression ratio engine and prevent the destruction of said piston(s) on the one hand, and to provide the gear system of said engine with suitable lubrication on the other hand, that the oil spray lubrication and cooling device for a variable compression ratio engine according to the invention differentiates itself from the prior art in that, according to one particular embodiment:
the temperature of the piston(s) of the variable compression ratio engine is controlled and always remains below the threshold above which a durable operation of the piston(s) is no longer assured;
the lubrication of the gear system of the variable compression ratio engine is improved in such a way that the durability of the contact surfaces of the various teeth of said system is assured in accordance with the desired service life of said engine.

The oil spray lubrication and cooling device for a variable compression ratio engine according to the present invention comprises at least one injector which is installed in the engine block of said variable compression ratio engine so as to spray oil on at least one of the moving components of said engine, said moving components being composed of at least one piston the lower portion of which is solidly connected to a transmitting member cooperating, on the one hand with a rolling guide device, and on the other hand with a toothed wheel, said toothed wheel cooperating on the one hand with a connecting rod connected to a crankshaft and on the other hand, on the opposite side from the transmitting member, with another rack called a control rack of which the vertical position in relation to the engine block is controlled by a control device.

The lubrication and cooling device according to the present invention comprises at least one injector installed in the engine block which sprays oil coming from the pressurized lubrication circuit of the engine.

The lubrication and cooling device according to the present invention comprises at least one injector which is installed in the engine block so as to spray oil under the crown of at least one piston included in the variable compression ratio engine, in order to cool said piston.

The lubrication and cooling device according to the present invention comprises at least one injector which is installed in the engine block so as to spray oil on the lower external surface of a bowl made in the upper portion of the crown of the piston, in order to cool said bowl.

The lubrication and cooling device according to the present invention includes a piston of which the lower external surface of the bowl made in the upper portion of the crown includes at least one oil trap which is formed by the rim of at least one recess, in order to keep the oil in contact with the underside of the crown of said piston during the accelerations and decelerations which said piston performs close to its top dead center.

The lubrication and cooling device according to the present invention comprises at least one injector which is installed in the engine block so as to spray oil into a scoop made under the piston of the engine, said scoop forcing said oil to go into a cavity made in the central portion of said piston.

The lubrication and cooling device according to the present invention comprises a piston of which the cavity made in the central portion of said piston includes in its upper end a cup, in order to keep some oil in contact with the underside of the crown of said piston during the accelerations and decelerations which said piston performs close to its top dead center.

The lubrication and cooling device according to the present invention comprises a piston of which the cavity made in the central portion of said piston includes in its upper portion a distribution chamber which comprises at least one hole emerging between the buttress ribs of the crown of said piston.

The lubrication and cooling device according to the present invention comprises at least one injector installed in the engine block which sprays oil into the inlet hole of at least one gallery made in the solid part of the piston, said gallery being located in the peripheral portion of said piston and under the crown of said piston.

The lubrication and cooling device according to the present invention comprises at least one injector which is installed in the engine block so as to spray oil on at least one transmitting member solidly connected to the lower portion of the or each piston of the variable compression ratio engine, in order to lubricate its large rack on the one hand, and in order to lubricate the teeth of the toothed wheel with which said rack cooperates on the other hand.

The lubrication and cooling device according to the present invention comprises at least one injector which is installed in the engine block so as to spray oil on at least one control rack of the variable compression ratio engine, in order to lubricate its large rack on the one hand, and in order to lubricate the teeth of the toothed wheel with which said rack cooperates on the other hand.

The lubrication and cooling device according to the present invention comprises at least one injector which is installed in the engine block so as to spray oil on at least one rolling guide device included in the variable compression ratio engine, in order to lubricate said rolling guide device.

The description which follows with reference to the attached drawings, given as nonlimiting examples, will make it possible to better understand the invention, the features it has and the advantages that it can provide:

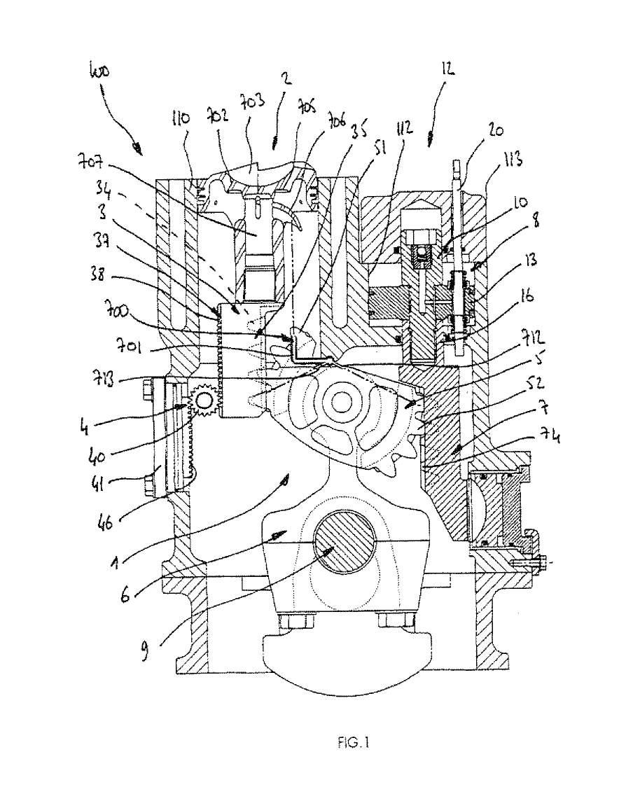

FIG. 1 is a section drawing illustrating a particular embodiment of the lubrication and cooling device according to the present invention.

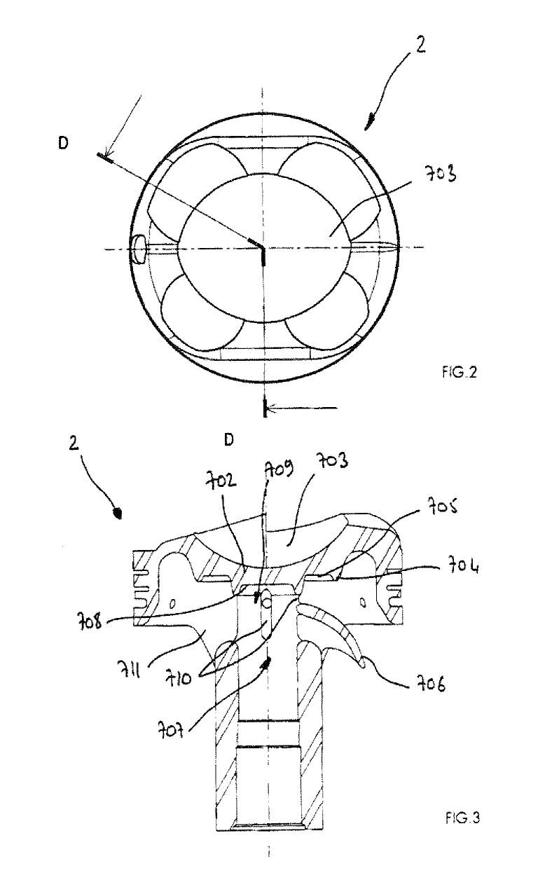

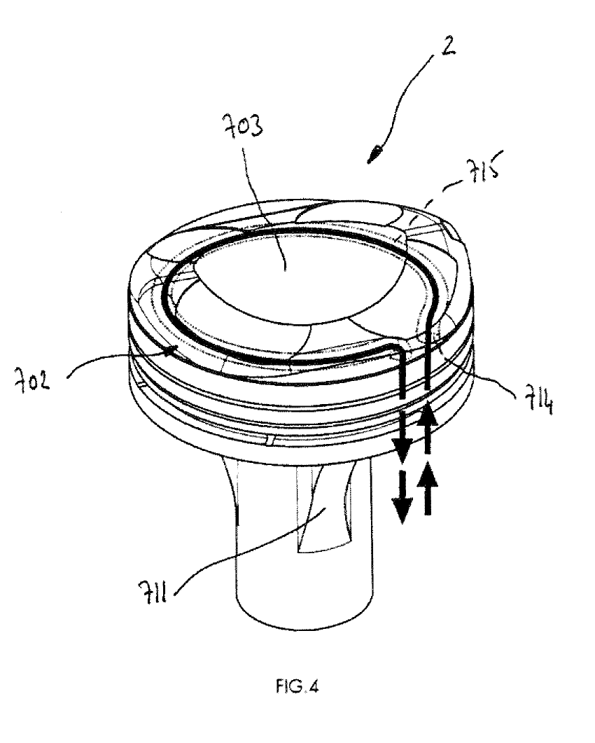

FIGS. 2 to 4 are drawings showing a piston for a variable compression ratio engine designed to cooperate with at least one oil injector which cools said piston.

Shown in FIG. 1 is a nonlimiting embodiment of the positioning and orientation of at least one injector 701 of the lubrication and cooling device 700 which is installed in the engine block 100 of a variable compression ratio engine so as to spray oil on at least one of the moving components of said engine, some of said components being designed to receive said oil.

The variable compression ratio engine includes for each cylinder 110 made in the engine block 100 a mechanical transmission device 1 including moving components which are composed of a piston 2, the lower part of which is solidly connected to a transmitting member 3 cooperating, on the one hand with a rolling guide device 4, and on the other hand with a toothed wheel 5.

The toothed wheel 5 cooperates with a connecting rod 6 connected to a crankshaft 9, in order to transmit the movement between the piston 2 and said crankshaft 9. The toothed wheel 5 cooperates, on the opposite side from the transmitting member 3, with a control rack 7 of which the vertical position in relation to the engine block 100 is controlled by a control device 12 including a control actuator 8, of which the actuator piston 13 is guided in an actuator cylinder 112 made in the engine block 100. The upper portion of the actuator cylinder 112 is closed by an actuator cylinder head 113 which can be bolted to the engine block 100.

The transmitting member 3 solidly connected to the piston 2 is provided on one of its faces with a first large rack 35 of which the teeth 34 cooperate with those 51 of the toothed wheel 5.

The transmitting member 3 includes, on the opposite side from the first rack 35, another rack 37 of which the small teeth 38 cooperate with those of a roller 40 of the rolling guide device 4.

The engine block 100 is solidly connected to a support 41 including racks 46 which synchronize the movement of the roller 40 with that of the piston 2.

The control rack 7, of which the vertical position in relation to the engine block 100 is controlled by a control device 12 including a control actuator 8 which is composed of an upper actuator rod 10, a lower actuator rod 16, an actuator piston 13 and a control rod 20.

The control rack 7 includes teeth 74 which cooperate with those 52 of the toothed wheel 5.

The lubrication and cooling device 700 comprises at least one injector 701, 712, 713 which is installed in the engine block 100 and which sprays oil coming from the pressurized lubrication circuit of the variable compression ratio engine.

The injector 701 is installed in the engine block 100 so as to spray oil under a crown 702 of at least one piston 2 included in the variable compression ratio engine, in order to cool said piston.

According to another embodiment, the injector can be installed in the engine block 100 so as to spray oil on a lower external surface of a bowl 703 made in the upper portion of the crown 702 of the piston 2, in order to cool said bowl.

The lower external surface of the bowl 703 made in the upper portion of the crown 702 of the piston 2 includes at least one oil trap 704 which is formed by the rim of at least one recess 705, in order to keep the oil in contact with the underside of the crown 702 of the piston 2 during the accelerations and decelerations which said piston performs close to its top dead center.

The injector 701 is installed in the engine block 100 so as to spray oil into at least one scoop 706 made under the piston 2 of the engine, said scoop forcing the oil to go into a cavity 707 made in the central portion of said piston.

The cavity 707 made in the central portion of the piston 2 includes in its upper end a cup 708, in order to keep some oil in contact with the underside of the crown 702 of said piston during the accelerations and decelerations which said piston performs close to its top dead center.

The cavity 707 made in the central portion of the piston 2 includes in its upper portion a distribution chamber 709 which comprises at least one hole 710 emerging between the buttress ribs 711 of the crown 702 of said piston.

According to another embodiment illustrated in FIG. 4, the injector can be installed in the engine block 100 so as to spray oil into an inlet hole 714 of at least one gallery 715 made in the solid part of the piston 2, said gallery being located in the peripheral portion of said piston and under the crown 702 of said piston.

It is noted that after cooling the piston 2, a portion of the oil sprayed under said piston 2 by the injector 701, then comes, when it descends again under gravity into the lubricating oil pan of the engine, to lubricate the mechanical transmission device 1 and more particularly the moving components composed of the transmitting member 3, the rolling guide device 4, and the toothed wheel 5. According to a particular embodiment, the oil output of the injector 701 can be controlled by the operating conditions of said engine.

According to another embodiment, an injector 713 can be installed in the engine block 100 so as to spray oil on at least one transmitting member 3 solidly connected to the lower portion of the or each piston 2 of the variable compression ratio engine, in order to lubricate the teeth 34 of the first large rack 35 on the one hand, and in order to lubricate the teeth 51 of the toothed wheel 5 with which said rack cooperates on the other hand.

According to another embodiment, an injector 712 installed in the engine block 100 can be designed to spray oil on at least one control rack 7, in order to lubricate its teeth 74 on the one hand, and in order to lubricate the teeth 52 of the toothed wheel 5 with which the control rack 7 cooperates on the other hand.

An oil injector can also be installed in the engine block 100 so as to spray oil on at least one rolling guide device 4.

It should moreover be understood that the foregoing description has only been given as an example and that it in no way limits the scope of the invention from which there will be no departure if the construction details described are replaced by any other equivalent.

1. An oil spray lubrication and cooling device for a variable compression ratio engine, characterized in that it comprises at least one oil injector (701, 712, 713) which is installed in the engine block (100) of said variable compression ratio engine so as to spray oil on at least one of the moving components of said engine, said moving components being composed of at least one piston (2) the lower portion of which is solidly connected to a transmitting member (3) cooperating with a rolling guide device (4) and a toothed wheel (5), said toothed wheel (5) cooperating on the one hand with a connecting rod (6) connected to a crankshaft (9) and on the other hand, on the opposite side from the transmitting member (3), with a control rack (7) of which the vertical position in relation to the engine block (100) is controlled by a control device (12).

2. The lubrication and cooling device as claimed in claim 1, characterized in that it comprises at least one oil injector (701) which is installed in the engine block (100) and which sprays oil coming from the pressurized lubrication circuit of the engine.

3. The lubrication and cooling device as claimed in claim 1, characterized in that the oil injector is installed in the engine block (100) so as to spray oil under a crown (702) of at least one piston (2) included in the variable compression ratio engine, in order to cool said piston.

4. The lubrication and cooling device as claimed in claim 3, characterized in that the oil injector is installed in the engine block (100) so as to spray oil on the lower external surface of a bowl (703) made in the upper portion of the crown (702) of the piston (2), in order to cool said bowl.

5. The lubrication and cooling device as claimed in claim 4, characterized in that the lower external surface of the bowl (703) made in the upper portion of the crown (702) of the piston (2) includes at least one oil trap (704) which is formed by the rim of at least one recess (705) which keeps some oil in contact with the underside of the crown (702) of said piston during the accelerations and decelerations which said piston performs close to its top dead center.

6. The lubrication and cooling device as claimed in claim 1, characterized in that the oil injector (701) is installed in the engine block (100) so as to spray oil into at least one scoop (706) made under the piston (2) of the engine, said scoop forcing said oil to go into a cavity (707) made in the central portion of said piston.

7. The lubrication and cooling device as claimed in claim 6, characterized in that the cavity (707) made in the central portion of the piston (2) includes in its upper end a cup (708), in order to keep some oil in contact with the underside of the crown (702) of said piston during the accelerations and decelerations which said piston performs close to its top dead center.

8. The lubrication and cooling device as claimed in claim 6, characterized in that the cavity (707) made in the central portion of the piston (2) includes in its upper portion a distribution chamber (709) which comprises at least one hole (710) emerging between the buttress ribs (711) of the crown (702) of said piston.

9. The lubrication and cooling device as claimed in claim 1, characterized in that the oil injector is installed in the engine block (100) so as to spray oil into the inlet hole (714) of at least one gallery (715) made in the solid part of the piston (2), said gallery being located in the peripheral portion of said piston and under the crown (702) of said piston.

10. The lubrication and cooling device as claimed in claim 1, characterized in that the oil injector (713) is installed in the engine block (100) so as to spray oil on at least one transmitting member (3) solidly connected to the lower portion of the or each piston (2) of the variable compression ratio engine, in order to lubricate its large rack (35) on the one hand, and in order to lubricate the teeth (51) of the toothed wheel (5) with which said rack cooperates on the other hand.

11. The lubrication and cooling device as claimed in claim 1, characterized in that the oil injector (712) is installed in the engine block (100) so as to spray oil on at least one control rack (7) of the variable compression ratio engine, in order to lubricate its teeth (74) on the one hand, and in order to lubricate the teeth (52) of the toothed wheel (5) with which said rack cooperates on the other hand.

12. The lubrication and cooling device as claimed in claim 1, characterized in that the oil injector is installed in the engine block (100) so as to spray oil on at least one rolling guide device (4).
